(19) United States
(12) Patent Application Publication
(10) Pub. No.: US 2021/0037118 A1
(43) Pub. Date: Feb. 4, 2021

(54) BURNING TOOL OF A TIRE PRESSURE SENSOR

(71) Applicant: Orange Electronic Co., Ltd, TAICHUNG CITY (TW)

(72) Inventors: Hung-Chih YU, TAICHUNG CITY (TW); Yi-Sheng LIN, TAICHUNG CITY (TW); Sheng-Ji CHENG, TAICHUNG CITY (TW); Po-Yu CHEN, TAICHUNG CITY (TW)

(73) Assignee: Orange Electronic Co., Ltd, TAICHUNG CITY (TW)

(21) Appl. No.: 16/821,172

(22) Filed: Mar. 17, 2020

(30) Foreign Application Priority Data
Aug. 1, 2019 (TW) 108127406

(51) Int. Cl. H04L 29/06; G01L 17/00; G06F 13/42

(52) U.S. Cl. CPC H04L 69/03; G06F 2213/0042; G06F 13/4282; G01L 17/00

(57) ABSTRACT

The present disclosure discloses a burning tool of a tire pressure sensor includes a carrier having at least one USB connector, an IC module and a transmission port. The USB connector is capable of externally matching a tire pressure sensor. The IC module includes a memory unit and a processing unit. The memory unit stores at least one communication protocol relative to a vehicle model. The processing unit is electrically connected to the memory unit and the USB connector, while the USB connector is in connection with the tire pressure sensor, the processing unit reads the communication protocol stored in the memory unit, and thereafter burns it into the tire pressure sensor. The transmission port is electrically connected with the IC module and capable of connecting with an external device, thus the IC module is controllable by the external device to burn the communication protocol aforesaid.

### RELATED APPLICATIONS

This application claims priority to Taiwan Application Serial Number 108127406, filed Aug. 1, 2019,which is herein incorporated by reference.

### BACKGROUND

### Technical Field

The present disclosure relates to a burning tool, and in particular to a burning tool of a tire pressure sensor which utilizes USB connectors to burn a communication protocol into several tire pressure sensors concurrently.

### Description of Related Art

The tire pressure sensors are applied for measurements of a tire like pressure and temperature, etc., and nowadays have been standard equipment in vehicles. Based on the reason of product lifetime, a tire pressure sensor must be replaced with a new one after a period of use. The tire pressure sensor is applicable to different models of vehicles, but in order to make it work normally, the communication protocol dedicated to these models of vehicles must be burned into the tire pressure sensor in advance.

In response to the mentioned requirement, a burning tool that can support the communication protocols of various car manufacturers is launched on the market. The existing burning tool burns tire pressure sensors one by one, precisely, the burning tool approaches and burns the tire pressure sensor with wireless induction or wired connection, and then repeat the above process for the next tire pressure sensor. However, for manufacturers which sell tire pressure sensors in large quantities, such a burning method is very labor-intensive and time-consuming.

In addition, in the case of burning many tire pressure sensors, it is difficult to prevent the wireless interference caused by these tire pressure sensors interacting with each other. This problem makes maintenance technicians need to isolate other tire pressure sensors during the burning process, so it is more troublesome in operation.

### SUMMARY

According to one aspect of the present disclosure, a burning tool of a tire pressure sensor includes a carrier having at least one USB connector, a power supply module, an IC module and a transmission port. The USB connector is capable of externally matching a tire pressure sensor. The power supply module is disposed in the carrier. The IC module is connected to the power supply module to obtain power and includes a memory unit, a communication unit and a processing unit. The memory unit stores at least one communication protocol relative to a vehicle model. The communication unit is capable of externally receiving the communication protocol and storing it into the memory unit. The processing unit is electrically connected to the memory unit, the communication unit and the USB connector, while the USB connector is in connection with the tire pressure sensor, the processing unit reads the communication protocol stored in the memory unit or the communication unit, and thereafter burns it into the tire pressure sensor.

According to another aspect of the present disclosure, a burning tool of a tire pressure sensor includes a carrier having at least one USB connector, an IC module and a transmission port. The USB connector is capable of externally matching a tire pressure sensor. The IC module includes a memory unit and a processing unit. The memory unit stores at least one communication protocol relative to a vehicle model. The processing unit is electrically connected to the memory unit and the USB connector, while the USB connector is in connection with the tire pressure sensor, the processing unit reads the communication protocol stored in the memory unit, and thereafter burns it into the tire pressure sensor. The transmission port is electrically connected with the IC module and capable of connecting with an external device, thus the IC module is controllable by the external device to burn the communication protocol aforesaid.

### BRIEF DESCRIPTION OF THE DRAWINGS

The disclosure can be more fully understood by reading the following detailed description of the embodiment, with reference made to the accompanying drawings as follows:

FIG. 1 is a block diagram of a burning tool of a tire pressure sensor according to one embodiment of the present disclosure;

FIG. 2 is a block diagram of a tire pressure sensor of the present disclosure;

FIG. 3A is an exploded diagram of the burning tool of a tire pressure sensor of FIG. 1;

FIG. 3B is a schematic diagram illustrating the assembly of the burning tool of a tire pressure sensor of FIG. 1;

FIG. 4 is a schematic diagram of a hand-held of the burning tool of a tire pressure sensor of FIG. 1;

FIG. 5 is a block diagram of a burning tool of a tire pressure sensor according to another embodiment of the present disclosure;

FIG. 6A is a schematic diagram of a hand-held of the burning tool of a tire pressure sensor of FIG. 5;

FIG. 6B is a schematic diagram illustrating a transmission line of the burning tool of a tire pressure sensor of FIG. 5; and

FIG. 6C is a schematic diagram illustrating an external box of the burning tool of a tire pressure sensor of FIG. 5.

### DETAILED DESCRIPTION

The following is the description of the present disclosure according the drawings. For describing precisely, the details in practice will be introduced as below, but the details should not be a limitation of the present disclosure. Namely, the details introduced in the specification are optional. Moreover, for simplifying the drawings, the conventional structures or members will be shown briefly therein, and the repeated members will be labeled as the same number.

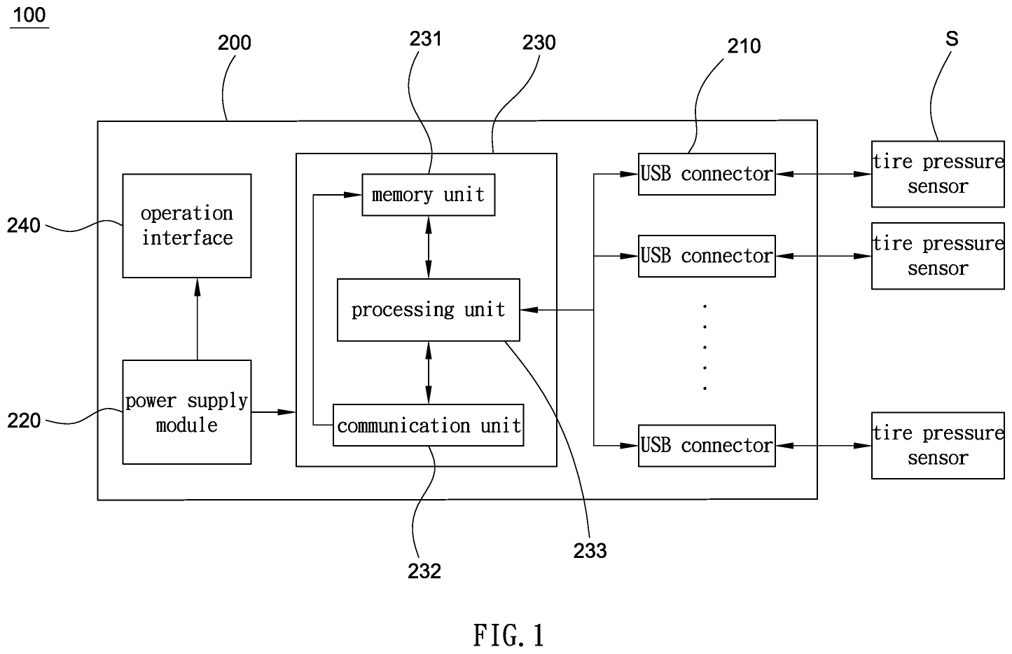

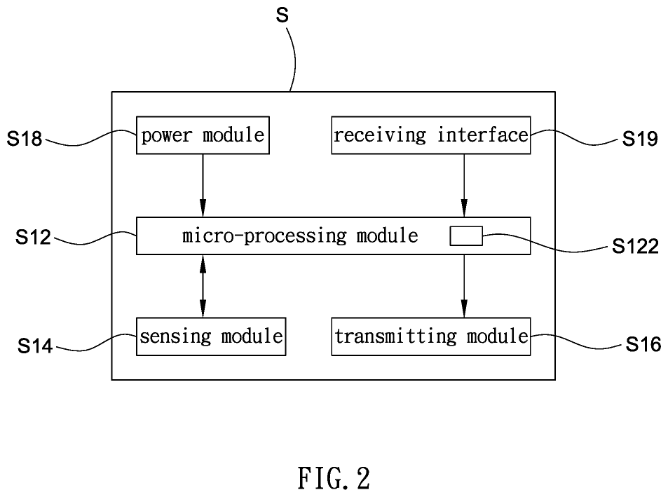

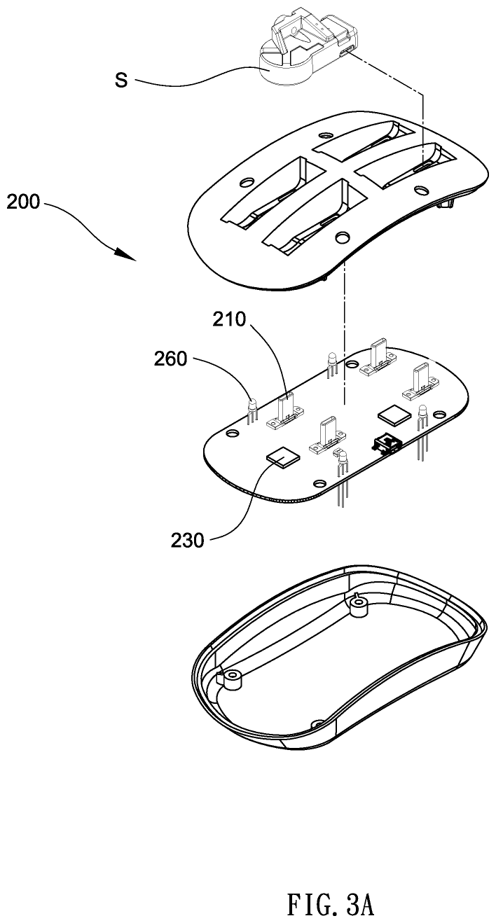

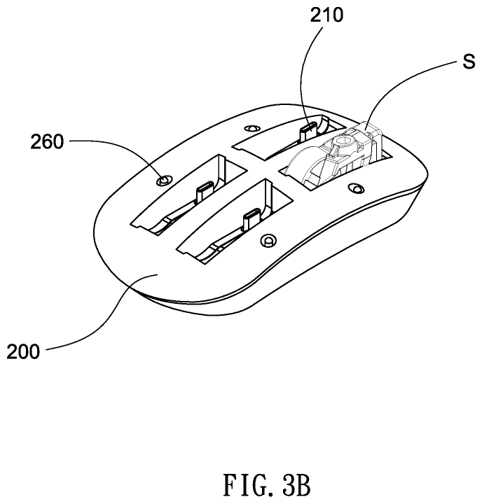

Please refer to FIG. 1, FIG. 2, FIG. 3A and FIG. 3B, the burning tool of a tire pressure sensor 100 includes a carrier 200 having a plurality of USB connectors 210, a power supply module 220 and an IC module 230. Each USB connector 210 can be of various USB specifications, such as Type-A, Type-B, USB-C, Mini-USB, Micro-USB, and is adapted to connect a tire pressure sensor S. The power supply module 220 (not shown in FIGS. 3A and 3B) is disposed inside the carrier 200 and supplies power to the IC module 230.

The IC module 230 includes a memory unit 231, a communication unit 232 and a processing unit 233. Various driving programs suitable for different transmission interfaces can be embedded in the memory unit 231, thus to ensure the tire pressure sensor S is correctly recognized by the IC module 230. Similarly, the memory unit 231 is also utilized to store a communication protocol corresponding to at least one vehicle model, and the communication protocol is accessed by the processing unit 233. In addition to interpreting the tire pressure sensor S and burning the communication protocol thereto according to the user's instructions, the central processing unit 233 is also used to detect the operating status of the tire pressure sensor burning device 100 or process the digital information transmitted from the tire pressure sensor S.

The tire pressure sensor S is with a USB port detachably connected with the USB connector 210. Preferably, the USB port of the tire pressure sensor S may be provided with a cover (not shown herein) to resist dust or moisture.

With reference to FIG. 2, the tire pressure sensor S is securely mounted on a valve stem inside a tire of a vehicle and has a micro-processing module S12, a sensing module S14, a transmitting module S16, a power module S18 and a receiving interface S19.

The micro-processing module S12 has a memory unit S122. The memory unit S122 is a writeable memory and may memorize a preset identification therein, where the preset identification may be an identical 8-bit integer numbered and is given when the tire pressure sensor S is manufactured. Either the memory unit S122 is empty without memorizing any preset identification therein.

The sensing module S14 is electronically connected to the micro-processing module S12 and may have a pressure-detecting unit, at least one acceleration-detecting unit, a temperature-detecting unit and/or the like. The sensing module S14 is controlled by the micro-processing module S12 to respectively detect continuously a tire pressure signal, acceleration direction signals and a tire temperature signal of the vehicle and send a detection result to the micro-processing module S12. Wherein, when two acceleration-detecting units are included, the two acceleration-detecting units may detect a turning acceleration and a tuning direction of the vehicle, where the turning acceleration and the tuning direction are calculated from the detection results of the acceleration-detecting units.

The transmitting module S16 is controlled by the micro-processing module S12 to transmit a radio frequency (RF signal, which includes the detection results and may have the preset identification.) The RF signal may have frequencies such as 315 MHz, 433 MHz or the like.

The power module S18 is electronically connected to the micro-processing module S12 and provides electric power to the tire pressure sensor S.

The receiving interface S19 is electronically connected to the micro-processing module S12, receives an external signal, outputs the external signal to the micro-processing module S12 and may be a connector or a low frequency receiver. The external signal may have an external identification thereby the micro-processing module S12 receives and memorizes the external identification into the memory unit S122 to overwrite and be the preset identification that is originally memorized in the memory unit S122. The low frequency receiver receives the external signal having a low frequency relating to the frequency of the RF signal. In a preferred embodiment of the present invention, the external signal is at kilo-Hz scale such like 125 kHz and is sent from the burning tool of a tire pressure sensor. A reason for adopting the low frequency receiver is that the low frequency wireless signal has a lower transparency, thereby the receiving interface S19 has to be placed nearby the burning tool of a tire pressure sensor when receiving the low frequency wireless signal from the source. Hence, a person may decide to receive the external signal from one particular source by adjusting a distance with the particular source.

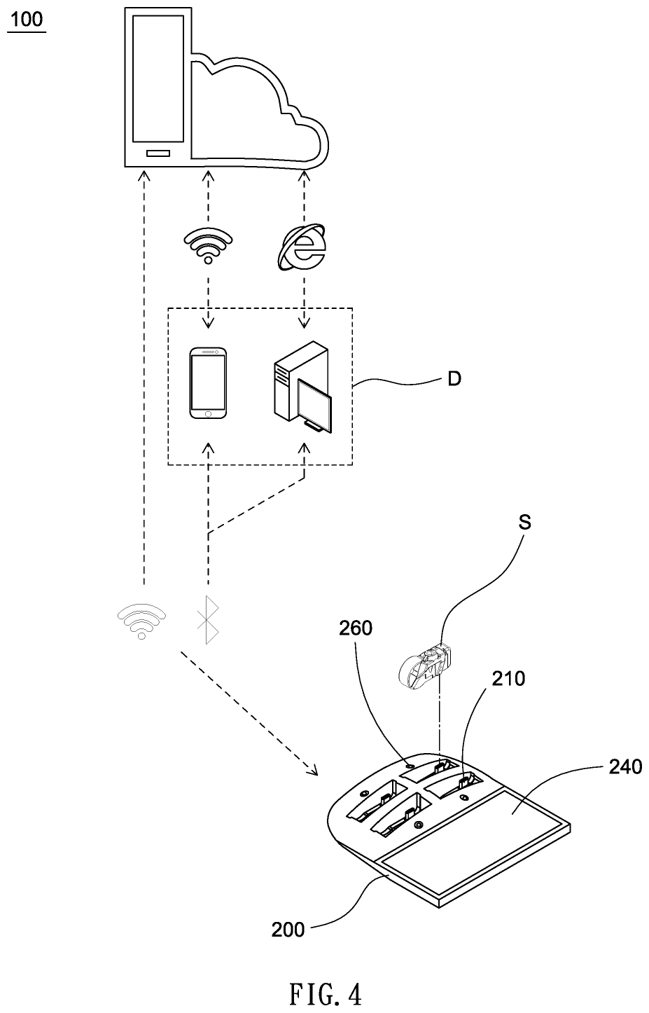

Please refer to FIG. 4, while at least one of the USB connectors is in connection with the tire pressure sensor S, the processing unit 233 first determines whether the model of the tire pressure sensor S is a supported by the tire pressure sensor burning device 100. After the tire pressure sensor S is determined to be supported, the processing unit 233 reads the memory unit 231 and checks if there is a communication protocol corresponding to the tire pressure sensor S therein. Alternatively, the central processing unit 233 may connect to the database through the communication unit 232 or an external device D to download the communication protocol directly, so as to burn the communication protocol into the tire pressure sensor S. Moreover, with connection to the communication unit 232, the central processing unit 233 may also update the edition of the communication protocol stored in the memory unit 231.

As shown in FIG. 4, the tire pressure sensor burning device 100 may also include an operation interface 240 electrically connected to the IC module 230. The operation on the communication unit 232 and the central processing unit 233 can be automatically executed by a program or performed by a user on the operation interface 240. In the embodiment shown in FIG. 4, the operation interface 240 can be implemented as a touch panel, but is not limited as described herein. For example, the operation interface 240 may also be implemented by a mechanical button or a piezoelectric button.

With the mentioned embodiment, the present disclosure can simultaneously burn the communication protocol to a plurality of the tire pressure sensors S with single burning tool, thereby improving the efficiency of detecting, updating the communication protocol, or replacing the tire pressure sensor. In addition, since the USB connector is directly connected or wired to the tire pressure sensors S, the signal will not be interfered even in the case of simultaneous burning.

Please refer to FIGS. 3A and 3B, the tire pressure sensor burning device 100 may also include a display unit 260 disposed on the carrier 200. The display unit 260 is considered to display the operating status of each of the USB connectors 210, the power supply module 220, the IC module 230 or the operation interface. Also, the display unit 260 can display the information of the communication protocol which is currently written to the tire pressure sensor S. In a better embodiment as shown in FIG. 4, the operation interface 240 and the display unit 260 may be integrated into a touch screen.

The communication unit 232 can be connected to the external device D such as a computer, a mobile device, a workstation or a cloud server to upload or download the operation message. For example, the operation message may include a sensor model information, a product inventory information, a consumer information, a car registration information, a repair manufacturer information or a time information. Additionally, the communication unit 232 and the external device D can be connected by wired communication or wireless communication, and the operation message can be automatically uploaded or downloaded while the burning tool of a tire pressure sensor 100 is idle.

The USB connectors 210 stated in the above embodiment may adapt a tire pressure sensor S with different transmission interfaces, such as UART, I-squared-C, SPI, or CAN bus, but not limited to those listed herein.

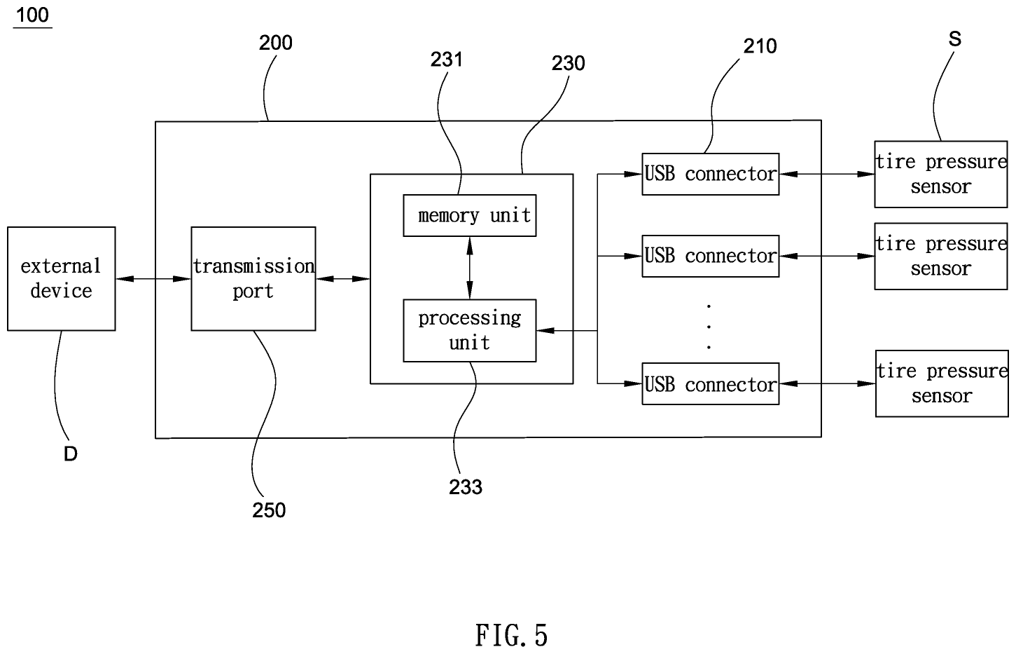

Please refer to FIG. 5, another embodiment of the disclosure provides a burning tool of a tire pressure sensor 100 includes a carrier 200 having a plurality of USB connectors 210, an IC module 230 and a transmission port 250. Each USB connector 210 can be of various USB specifications, such as Type-A, Type-B, USB-C, Mini-USB, Micro-USB, and is adapted to connect a tire pressure sensor S. The USB connectors 210 may adapt a tire pressure sensor S with different transmission interfaces, such as UART, I-squared-C, SPI, or CAN bus, but not limited to those listed herein.

The IC module 230 includes a memory unit 231 and a processing unit 233. The memory unit 231 may be embedded with various driving programs suitable for different transmission interfaces, therefore a communication protocol corresponding to at least one vehicle model can be stored in the memory unit 231 and accessible to the processing unit 233.

The processing unit 233 is electrically connected to the memory unit 231 and the USB connectors 210, while at least one of the USB connector 210 is in connection with the tire pressure sensor S, the processing unit 233 reads the communication protocol stored in the memory unit 231, and thereafter burns it into the tire pressure sensor S.

The transmission port 250 is electrically connected with the IC module 230 and capable of connecting with an external device D. In this embodiment, the processing unit 233 can be controlled by the external device D via the transmission port 250, hence the operation interface 240 may be omitted herein. Further, because burning tool of a tire pressure sensor 100 can be powered by the external device D, the power supply module 220 mentioned in the previous embodiment can also be omitted.

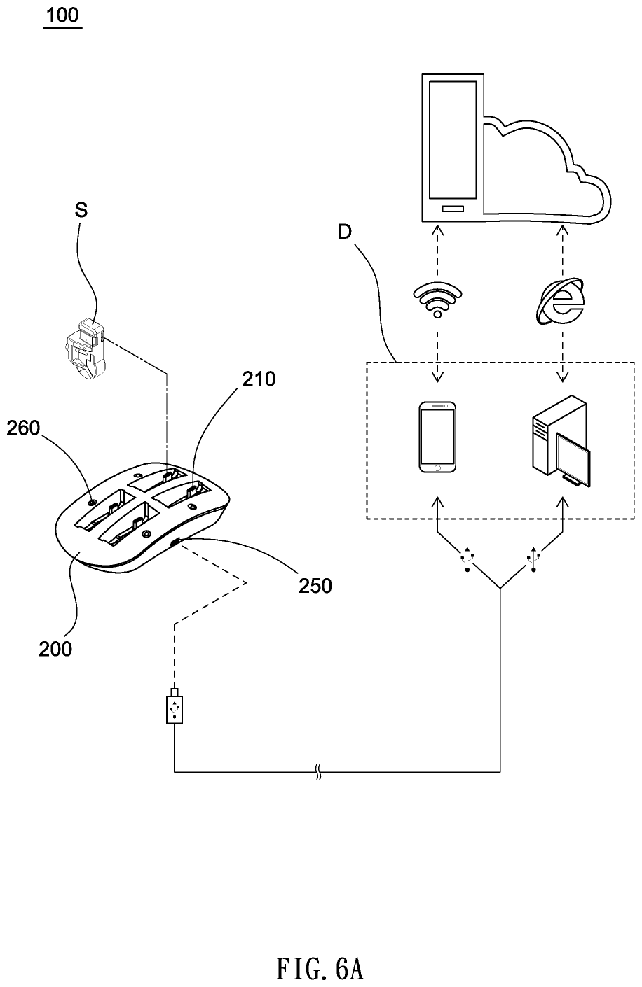

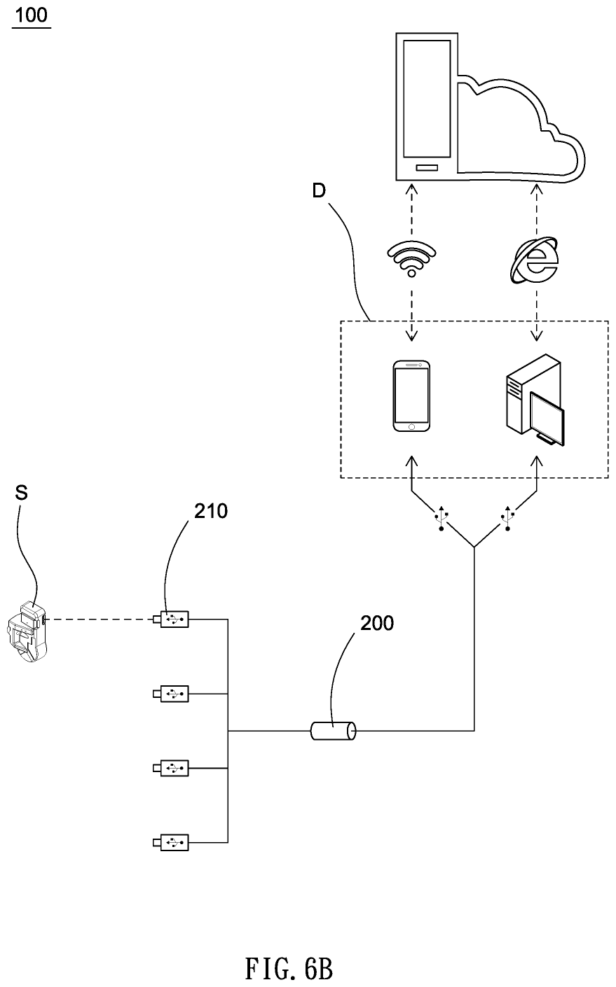

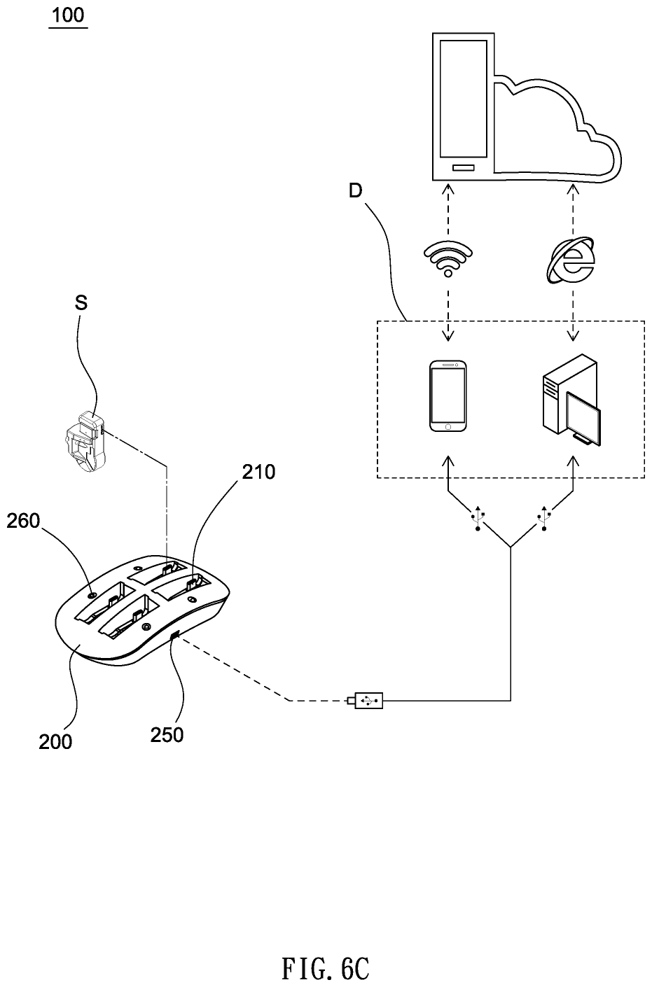

Please refer to FIGS. 6A, 6B and 6C, regarding the burning tool of a tire pressure sensor 100, the similarity between this embodiment and the first embodiment will not be described herein. The main feature of this embodiment is that the IC module 230 is driven by external control. Namely, in this embodiment, the burning tool of a tire pressure sensor 100 cannot directly burn a communication protocol or transmit information.

In this case, since it is unnecessary for a user to operate the burning tool of a tire pressure sensor 100 directly, the appearance thereof is not limited the hand-held tool shown in FIG. 6A. For instance, the burning tool of a tire pressure sensor 100 may be a transmission line shown in FIG. 6B or an external box in FIG. 6C, and has more options for implementation. Additionally, this embodiment is applicable to an environment without a wireless network. The user can use a physical cable to connect the burning tool of a tire pressure sensor 100 to the external device D such as a computer, mobile device, workstation, or cloud server, so as to transfer operation message bilaterally. The operation message described herein includes, but is not limited to, a sensor model information, a product inventory information, a consumer information, a car registration information, a repair manufacturer information or a time information.

The tire pressure sensor burning device 100 may also include a display unit 260 disposed on the carrier 200. The display unit 260 is considered to display the operating status of each of the USB connectors 210 and the IC module 230.

According to the aforementioned embodiments, by using a plurality of USB connectors, the present disclosure solves the problem of low efficiency of the conventional burning device for tire pressure sensor. On the top of that, based on the wired connection, the operation signal for burning communication protocol will not interfered by noise, thereby improving the reliability of the burning tool of a tire pressure sensor.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

1. A burning tool of a tire pressure sensor, comprising:
a carrier which having:
a plurality of USB connectors, each of the USB connectors being capable of externally matching a tire pressure sensor;
a power supply module disposed in the carrier; and
an IC module connected to the power supply module to obtain power, comprising:
a memory unit storing at least one communication protocol relative to a vehicle model;
a communication unit capable of externally receiving the communication protocol and storing it into the memory unit; and
a processing unit electrically connected to the memory unit, the communication unit and the USB connectors, while one of the USB connectors is in connection with the tire pressure sensor, the processing unit reads the communication protocol stored in the memory unit or the communication unit, and thereafter burns it into the tire pressure sensor.

2. The burning tool of a tire pressure sensor of claim 1, wherein the communication unit transmits an operation message outwardly, and the operation message comprises a sensor model information, a product inventory information, a consumer information, a car registration information, a repair manufacturer information or a time information.

3. The burning tool of a tire pressure sensor of claim 2, wherein the communication unit is connected to a computer, a mobile device, a workstation or a cloud server to upload or download the operation message.

4. The burning tool of a tire pressure sensor of claim 2, wherein the operation message is transmitted via wireless communication.

5. The burning tool of a tire pressure sensor of claim 1, further comprising:
an operation interface electrically connected to the IC module, the operation interface being considered to control the processing unit for burning the communication protocol.

6. The burning tool of a tire pressure sensor of claim 5, wherein the operation interface is a touch panel or a button.

7. The burning tool of a tire pressure sensor of claim 1, further comprising:
a display unit disposed on the carrier and displaying an operating status of the USB connectors, the power supply module or the IC module.

8. The burning tool of a tire pressure sensor of claim 5, further comprising:
a display unit disposed on the carrier and displaying an operating status of the operation interface.

9. The burning tool of a tire pressure sensor of claim 1, wherein the tire pressure sensor communicates with the burning tool through UART interface, I-squared-C interface, SPI interface or CAN bus interface.

10. The burning tool of a tire pressure sensor of claim 1, wherein each of the USB connectors is a USB Type-A port, a USB Type-B port, a USB-C port, a Mini-USB port or a Micro-USB port.

11. A burning tool of a tire pressure sensor, comprising:
a carrier which having:
a plurality of USB connectors, each of the USB connectors being capable of externally matching a tire pressure sensor;
an IC module, comprising:
a memory unit storing at least one communication protocol relative to a vehicle model; and
a processing unit electrically connected to the memory unit and the USB connectors, while one of the USB connectors is in connection with the tire pressure sensor, the processing unit reads the communication protocol stored in the memory unit, and thereafter burns it into the tire pressure sensor; and
a transmission port electrically connected with the IC module and capable of connecting with an external device;
wherein while the IC module is connected with and operated by the external device, the processing unit is controllable to burn the communication protocol.

12. The burning tool of a tire pressure sensor of claim 11, wherein a communication unit transmits an operation message outwardly, and the operation message comprises a sensor model information, a product inventory information, a consumer information, a car registration information, a repair manufacturer information or a time information.

13. The burning tool of a tire pressure sensor of claim 12, wherein the communication unit is connected to a computer, a mobile device, a workstation or a cloud server to upload or download the operation message.

14. The burning tool of a tire pressure sensor of claim 11, further comprising:
a display unit disposed on the carrier and displaying an operating status of the USB connectors or the IC module.

15. The burning tool of a tire pressure sensor of claim 11, where the carrier is a hand-held tool, a transmission line or an external box.

16. The burning tool of a tire pressure sensor of claim 11, wherein the tire pressure sensor communicates with the burning tool through UART interface, I-squared-C interface, SPI interface or CAN bus interface.

17. The burning tool of a tire pressure sensor of claim 11, wherein each of the USB connectors is a USB Type-A port, a USB Type-B port, a USB-C port, a Mini-USB port or a Micro-USB port.
